(19) United States
(12) Patent Application Publication
(10) Pub. No.: US 2024/0231922 A1
(43) Pub. Date: Jul. 11, 2024

(54) ANTI-AFFINITY FOR CONTAINERIZED COMPUTING SERVICE

(71) Applicant: VMware, Inc., Palo Alto, CA (US)

(72) Inventors: Ryan BRADFORD, San Francisco, CA (US); Benjamin DUONG, Medford, CA (US)

(21) Appl. No.: 18/153,203

(22) Filed: Jan. 11, 2023

(51) Int. Cl. G06F 9/50

(52) U.S. Cl. CPC G06F 9/5027

(57) ABSTRACT

A method for removing redundant channels between a client and pods of a service is provided. Some embodiments include sending, from the client to the service, a first request for an application exposed by the service, the first request corresponding to a request for a first channel, receiving from a first pod associated with the service, a response indicating acceptance of the first request, establishment of the first channel between the first pod and the client, and an identifier of the first pod, and storing an association between the first channel and the name of the first pod. In some embodiments, the method includes determining whether any pod is associated with multiple channels in the data structure and in response to determining that the first pod is associated with the first channel and one or more other channels, shutting down the one or more other channels.

### BACKGROUND

Many current applications can be deployed in a public cloud, private data center, or multi-cloud or hybrid cloud fashion, such as, consuming both cloud services executing in a public cloud and local services executing in a private data center. Within the public cloud or private data center, modern applications can be deployed onto one or more virtual machines (VMs), containers, application services, and/or the like.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods.

Containerized workloads run on a container orchestration platform that enables the automation of much of the operational effort required to run containers having workloads and services. This operational effort includes a wide range of actions to manage a container's lifecycle, including, but not limited to, provisioning, deployment, scaling (up and down), networking, and load balancing.

Kubernetes® software is an example open-source container orchestration platform that automates the operation of such containerized workloads. In a Kubernetes environment, pods running applications are not directly exposed outside of the Kubernetes environment, meaning they are not directly accessible to client devices outside of the Kubernetes environment. Rather, a Kubernetes service is provided that exposes an application running on a set of pods as a network service accessible to client devices outside of the Kubernetes environment. For example, multiple instances of an application may run in the Kubernetes environment, each instance running on a particular pod. Therefore, client requests to the application can be load balanced to different pods. The Kubernetes service associated with an application, therefore, may receive a client request for the application, select a pod running an instance of the application at random, and send the client request to the randomly selected pod.

For receiving client requests, the Kubernetes environment includes an API object, referred to as an ingress that manages external access to Kubernetes services running in the Kubernetes environment. The ingress may run, for example, in a gateway device of the Kubernetes environment. A client device may issue a request for an application exposed by a Kubernetes service to the ingress. The ingress forwards the request to the Kubernetes service. The Kubernetes service then randomly selects a pod and forwards the request to the pod for handling, as discussed.

In certain cases, a connection (also referred to as a channel) is formed between the client device and the selected pod (e.g., via the ingress and the Kubernetes service) for servicing the request and subsequent requests, based on the initial request for the channel. In certain cases, a single client device may have many requests for an application exposed by a Kubernetes service, and therefore it may be useful to load balance the requests across multiple different pods of the Kubernetes service. Accordingly, a client device may make several channels to the ingress by which to send requests to the application exposed by the Kubernetes service. Each channel of the ingress may be made with a pod selected at random by the Kubernetes service to service the initial request for the channel. Therefore, each channel may potentially correspond to a different pod, such that requests sent by the client device on different channels are handled by different pods. However, since pods are selected by the Kubernetes service at random, it is not possible to guarantee that different channels of the client device are associated with different pods, as the same pod may be selected for different channels. Where different channels are associated with the same pod, client device requests may not be load balanced between different pods.

It should be noted that the information included in the Background section herein is simply meant to provide a reference for the discussion of certain embodiments in the Detailed Description. None of the information included in this Background should be considered as an admission of prior art.

### SUMMARY

A method for removing redundant channels between a client and pods of a service is provided. Some embodiments include sending, from the client to the service, a first request for an application exposed by the service, the first request corresponding to a request for a first channel, receiving from a first pod associated with the service, a response indicating acceptance of the first request, establishment of the first channel between the first pod and the client, and an identifier of the first pod, and storing an association between the first channel and the name of the first pod. In some embodiments, the method includes determining whether any pod is associated with multiple channels in the data structure and in response to determining that the first pod is associated with the first channel and one or more other channels, shutting down the one or more other channels.

Another embodiment includes a system for removing redundant channels between a client and pods of a service. Embodiments of the system include at least one processor and at least one memory, the at least one processor and the at least one memory configured to cause the system to send, from the client to the service, a first request for an application exposed by the service, the first request corresponding to a request for a first channel, receive, at the client from a first pod associated with the service, a response indicating acceptance of the first request, establishment of the first channel between the first pod and the client, and an identifier of the first pod, and store, in a data structure associating channels with pods of the service, an association between the first channel and the name of the first pod. Some embodiments cause the system to determine whether any pod is associated with multiple channels in the data structure and in response to determining that the first pod is associated with the first channel and one or more other channels, shut down the one or more other channels.

Another embodiment includes a non-transitory computer-readable medium for removing redundant channels between a client and pods of a service. Embodiments of the non-transitory computer-readable medium include instructions that, when executed by at least one processor of a computing system, cause the computing system to send, from the client to the service, a first request for an application exposed by the service, the first request corresponding to a request for a first channel, receive, at the client from a first pod associated with the service, a response indicating acceptance of the first request, establishment of the first channel between the first pod and the client, and an identifier of the first pod, and store, in a data structure associating channels with pods of the service, an association between the first channel and the name of the first pod. Some embodiments of the non-transitory computer-readable medium determine whether any pod is associated with multiple channels in the data structure and in response to determining that the first pod is associated with the first channel and one or more other channels, shutting down the one or more other channels.

These and additional features provided by the embodiments of the present disclosure will be more fully understood in view of the following detailed description, in conjunction with the drawings.

### BRIEF DESCRIPTION OF THE DRAWINGS

FIG. 1A depicts example physical and virtual components in a networking environment in which embodiments of the present application may be implemented.

FIG. 1B illustrates an example cluster for running containerized workloads in the computing system of FIG. 1A, according to an example embodiment of the present disclosure.

FIG. 2 depicts a sequence diagram of a process for establishing a channel with a pod, according to an example embodiment of the present application.

FIG. 3 depicts a flowchart of a process for removing redundant channels to the same pod of a service, according to an example embodiment of the present application.

### DETAILED DESCRIPTION

Aspects of the present application present techniques for spreading channels from a single client (e.g., a physical computing device, a virtual computing instance, etc.) to a plurality of Kubernetes pods that back a Kubernetes service. As discussed, the client establishes long-lived channels with pods of a Kubernetes service, via an ingress and the Kubernetes service, by sending a request to the ingress, which forwards the request to the Kubernetes service, which selects a pod at random to service the request. In certain embodiments, the pod that receives the request accepts/forms the channel by accepting the request. The receiving pod then sends a message back to the client indicating the unique name (e.g., UUID) of the Kubernetes pod that accepted the request.

The client receives this message, and stores an indication of an association between the channel and the unique name of the receiving pod. For example, the client stores in a data structure that the receiving pod is the “CONNECTED_POD” associated with the channel. In certain aspects, the data structure includes identifiers of multiple (e.g., all) channels between the client and the Kubernetes service, each channel associated with the unique name of the pod that is the “CONNECTED_POD” for the channel.

Periodically, the client takes an inventory of all the channels that have been created for the service, such as by processing the data in the data structure. In particular, the client checks the data structure to determine if any channels share the same “CONNECTED_POD.” Multiple (e.g., two or more) channels sharing the same “CONNECTED_POD” is considered an anti-affinity violation. In particular, this means that requests sent on the multiple channels are sent to the same pod, such that there is no load balancing between the multiple channels. Accordingly, in certain embodiments, for each pod shared by multiple channels, the client then shuts down (e.g., begins a graceful shutdown) all but one of the multiple channels. Accordingly, every remaining channel between the client and the service is connected to a unique pod of the service.

The client then re-establishes a new channel with the Kubernetes service for every old channel that was closed because sharing a “CONNECTED_POD” with another channel. The pods associated with the new channels are again chosen at random by the Kubernetes service. Accordingly, as the client periodically takes an inventory of the channels created for the service again, the client may determine some new channels share the same “CONNECTED_POD” and perform the shut down of channels and re-establishment of channels again. In certain aspects, as long as the client is establishing a number of channels that is less than or equal to the number of Kubernetes pods backing the service, in the long run, each channel from the client will be connected to a unique pod.

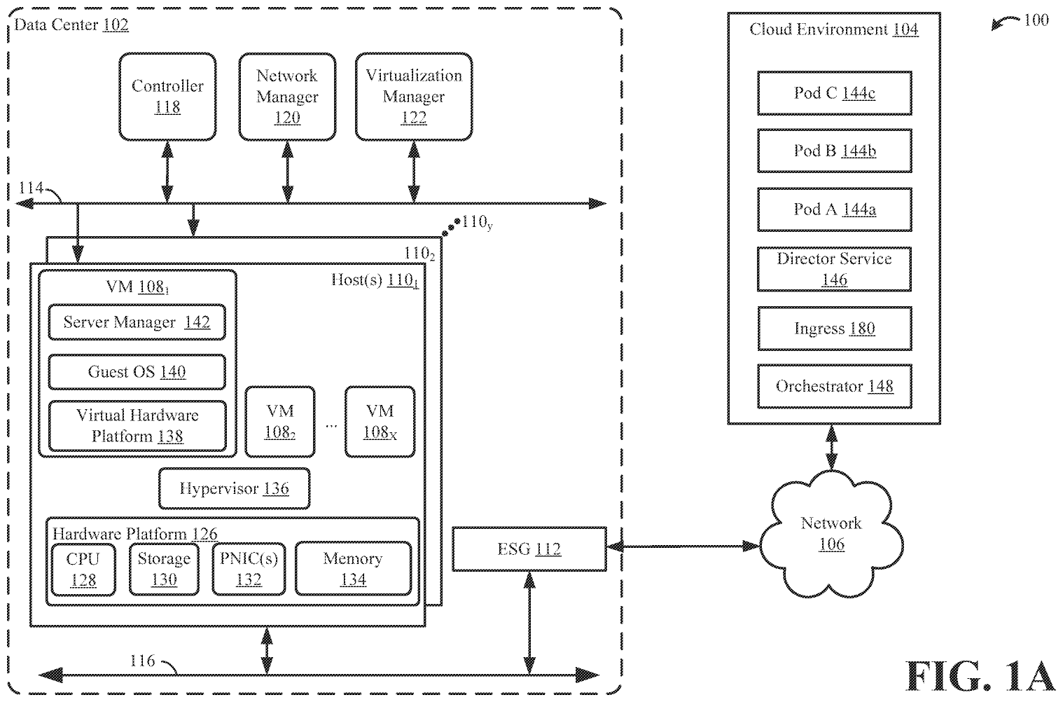

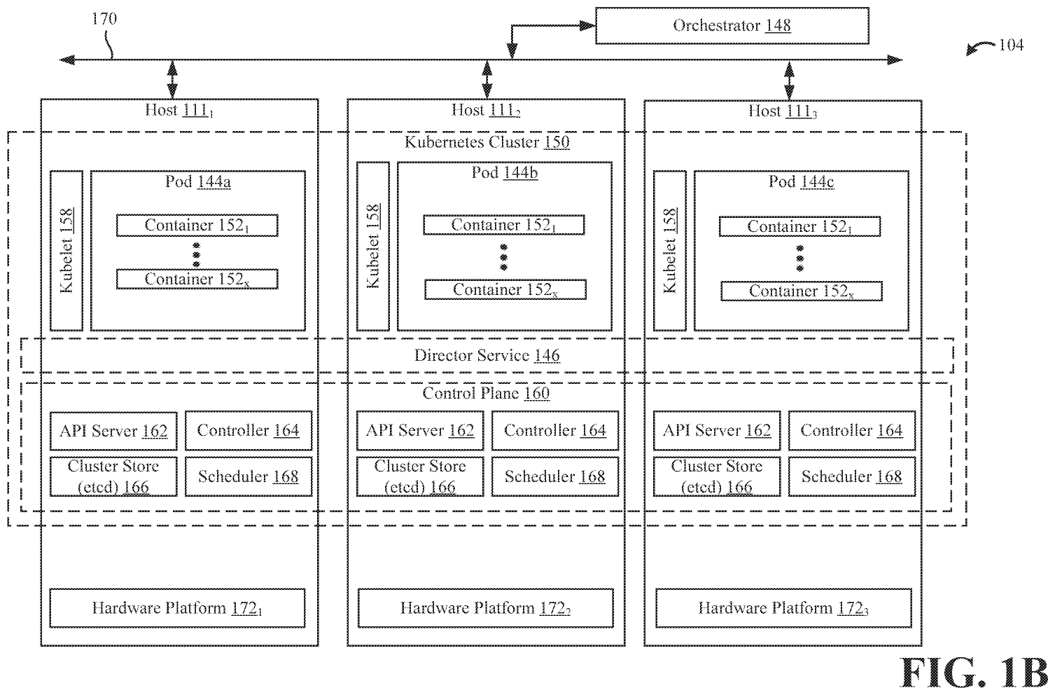

Referring now to the drawings, FIG. 1A depicts example physical and virtual network components in a networking environment 100 in which embodiments of the present application may be implemented. Networking environment 100 includes a data center 102 and cloud environment 104, coupled together via a network 106. The data center 102 may include one or more physical computing devices, e.g., running one or more virtual machines (VMs) 108. Cloud environment 104 may provide a containerized cloud service and may similarly include one or more physical computing devices, as described in more detail below. Depending on the particular embodiment, data center 102 may be configured as a cloud data center or an on-premises data center. Though certain aspects are discussed with respect to a Kubernetes platform including a Kubernetes service running in a cloud environment 104, the techniques discussed herein are applicable regardless of the computing environment in which the Kubernetes platform runs.

Data center 102 and cloud environment 104 may communicate via the network 106. Network 106 may be an external network. Network 106 may be a layer 3 (L3) physical network. Network 106 may be a public network, a wide area network (WAN) such as the Internet, a direct link, a local area network (LAN), another type of network, or a combination of these.

Data center 102 includes one or more hosts 110 (e.g., 110₁, 110₂, . . . , 110_{y}) an edge services gateway (ESG) 112, a management network 114, a data network 116, a controller 118, a network manager 120, and a virtualization manager 122. Management network 114 and data network 116 may be implemented as separate physical networks or as separate virtual local area networks (VLANs) on the same physical network.

Host(s) 110 may be communicatively connected to both management network 114 and data network 116. Management network 114 and data network 116 are also referred to as physical or “underlay” networks, and may be separate physical networks or the same physical network. As used herein, the term “underlay” maybe synonymous with “physical” and refers to physical components of networking environment 100. As used herein, the term “overlay” may be used synonymously with “logical” and refers to the logical network implemented at least partially within networking environment 100.

Each of hosts 110 may be constructed on a hardware platform 126, which may be server grade, such as an x86 architecture platform. Hosts 110₁, . . . , 110_{y} (collectively or individually referred to as host(s) 110) may be geographically co-located servers on the same rack or on different racks. In some embodiments, one or more of the hosts 110 may be located remote from the data center 102 and/or as part of a different data center and coupled to the network 106.

Hardware platform 126 of a host 110 may include components of a computing device such as at least one processor (CPUs) 128, storage 130, one or more network interfaces (e.g., physical network interface cards (PNICs) 132), system memory 134, and other components (not shown). A CPU 128 is configured to execute instructions, for example, executable instructions that perform one or more operations described herein and that may be stored in the memory and storage system. The network interface(s) enable host 110 to communicate with other devices via a physical network, such as management network 114 and data network 116.

Each host 110 may be configured to provide a virtualization layer, also referred to as a hypervisor 136. The hypervisor 136 abstracts processor, memory, storage, and networking physical resources of hardware platform 126 into a number of virtual machines (VMs) 108₁, . . . 108ₓ (collectively or individually referred to as VM(s) 108) on hosts 110. As shown, multiple VMs 108 may run concurrently on the same host 110.

A virtual machine 108 implements a virtual hardware platform 138 that supports the installation of a guest OS 140 which is capable of executing one or more applications. Guest OS 140 may be a standard, commodity operating system. Examples of a guest OS 140 include Microsoft Windows, Linux, and the like.

In certain aspects, a VM 108 includes a server manager 142. The server manager 142 may be configured as a piece of software that is communicated from the cloud environment 104 to the VM 108. The server manager 142 may be configured to communicate with the cloud environment 104 to determine which pods 144 have established channels with hosts 110.

Certain aspects are discussed herein with respect to the VM 108 including the server manager 142 as an example client and director service 146 as an example Kubernetes service. However, it should be understood that the techniques discussed herein can be applied to any suitable client and service. In some embodiments, the server manager 142 may be configured to account for which pods 144 have established channels, as well as initiate disconnection of one or more channels, as described in more detail below.

Each hypervisor 136 may run in conjunction with an operating system (OS) in its respective host 110. In some embodiments, hypervisors can be installed as system level software directly on hardware platforms of its respective host 110 (e.g., referred to as “bare metal” installation) and be conceptually interposed between the physical hardware and the guest OSs executing in the VMs 108. Though certain aspects are described herein with respect to VMs 108 running on hosts 110, it should be understood that such aspects are similarly applicable to physical machines, like hosts 110, without the use of virtualization.

ESG 112 is configured to operate as a gateway device that provides components in data center 102 with connectivity to an external network, such as network 106. ESG 112 may manage external public IP addresses for VMs 108. ESG 112 may include a router (e.g., a virtual router and/or a virtual switch) that routes traffic incoming to and outgoing from data center 102. ESG 112 also provides other networking services, such as firewalls, network address translation (NAT), dynamic host configuration protocol (DHCP), and load balancing. ESG 112 may be referred to as a nested transport node, for example, as the ESG 112 may perform encapsulation and decapsulation. ESG 112 may be a stripped down version of a Linux transport node, with the hypervisor 136 module removed, tuned for fast routing. The term, “transport node” refers to a virtual or physical computing device that is capable of performing packet encapsulation/decapsulation for communicating overlay traffic on an underlay network.

While ESG 112 is illustrated in FIG. 1A as a component outside of host 110, in some embodiments, ESG 112 may be situated on host 110 and provide networking services, such as firewalls, NAT, DHCP, and load balancing services as a VM.

Data center 102 also includes a management plane and a control plane. The management plane and control plane each may be implemented as single entities (e.g., applications running on a physical or virtual compute instance), or as distributed or clustered applications or components. In some embodiments, a combined manager/controller application, server cluster, or distributed application, may implement both management and control functions. In some embodiments, network manager 120 at least in part implements the management plane and controller 118 at least in part implements the control plane.

The control plane determines the logical overlay network topology and maintains information about network entities such as logical switches, logical routers, and endpoints, etc. The logical topology information is translated by the control plane into network configuration data that is then communicated to network elements of host(s) 110. Controller 118 generally represents a control plane that manages configuration of VMs 108 within data center 102. Controller 118 may be one of a plurality of controllers executing on various hosts 110 in the data center 102 that together implement the functions of the control plane in a distributed manner. Controller 118 may be a computer program that resides and executes in the data center 102 or, in some aspects, controller 118 may run as a virtual appliance (e.g., a VM 108) in one of hosts 110. Although shown as a single unit, it should be understood that controller 118 may be implemented as a distributed or clustered system. That is, controller 118 may include multiple servers or virtual computing instances that implement controller functions. It is also possible for controller 118 and network manager 120 to be combined into a single controller/manager. Controller 118 collects and distributes information about the network from and to endpoints in the network. Controller 118 is associated with one or more virtual and/or physical CPUs. Processor(s) resources allotted or assigned to controller 118 may be unique to controller 118, or may be shared with other components of the data center 102. Controller 118 communicates with hosts 110 via management network 114, such as through control plane protocols. In some embodiments, controller 118 implements a central control plane (CCP).

Network manager 120 and virtualization manager 122 generally represent components of a management plane that include one or more computing devices responsible for receiving logical network configuration inputs, such as from a user or network administrator, defining one or more endpoints and the connections between the endpoints, as well as rules governing communications between various endpoints.

In some embodiments, virtualization manager 122 is a computer program that executes in a server in data center 102 (e.g., the same or a different server than the server on which network manager 120 executes), or in some aspects, virtualization manager 122 runs in one or more of VMs 108. Virtualization manager 122 is configured to carry out administrative tasks for data center 102, including managing hosts 110, managing VMs 108 running within each host 110, provisioning VMs 108, transferring VMs 108 from one host 110 to another host 110, transferring VMs 108 between data centers 102, transferring application instances between VMs 108 or between hosts 110, and load balancing among hosts 110 within data center 102. Virtualization manager 122 takes commands as to creation, migration, and deletion decisions of VMs 108 and application instances on the data center 102. However, virtualization manager 122 also makes independent decisions on management of local VMs 108 and application instances, such as placement of VMs 108 and application instances between hosts 110. In some embodiments, virtualization manager 122 also includes a migration component that performs migration of VMs 108 between hosts 110, such as by live migration.

In some embodiments, network manager 120 is a computer program that executes in a central server in networking environment 100, or in some embodiments, network manager 120 may run in a VM 108, e.g., in one of hosts 110. Network manager 120 communicates with host(s) 110 via management network 114. Network manager 120 may receive network configuration input from a user or an administrator and generate desired state data that specifies how a logical network should be implemented in the physical infrastructure of the data center 102.

Network manager 120 is configured to receive inputs from an administrator or other entity, e.g., via a web interface or application programming interface (API), and carry out administrative tasks for the data center 102, including centralized network management and providing an aggregated system view for a user.

Also coupled to the network 106 is cloud environment 104. Cloud environment 104 may include a plurality of physical host devices, one or more of which is configured to run a container orchestration platform, shown as orchestrator 148. The orchestrator 148 is configured to provision and manage pods of containers on one or more of the plurality of physical host devices, as discussed. In certain aspects, orchestrator 148 provisions multiple pods, each pod running an instance of a director application. Orchestrator 148 further provisions a Kubernetes service, director service 146 that exposes the director application running on multiple pods including pod 144a, pod 144b, and pod 144c. Orchestrator 148 further configures ingress 180, which manages external access to services, such as director service 146, from external sources such as VM 108. In certain aspects, ingress 180 runs on a gateway in cloud environment 104, similar to ESG 112.

FIG. 1B illustrates an example cluster for running containerized workloads in the cloud environment 104 of FIG. 1A, according to an example embodiment of the present disclosure. As illustrated, Kubernetes cluster 150 is formed from a combination of one or more hosts 111 running one or more pods 144 that include one or more containers 152, one or more kubelets 158, the director service 146, and a control plane 160. In an example, the containers 152 of each of pods 144 may run workloads corresponding to a director application. However, there may be fewer or greater number of pods, and they may support additional or different service(s). Additionally, while three hosts 111 and three pods 144 are depicted in FIG. 1B, this is also just an example, as more or fewer may be implemented, depending on the embodiment.

Although not explicitly illustrated in FIG. 1B, Kubernetes cluster 150 may include one or more kube proxies. A kube proxy is a network proxy that runs on each host 111 in Kubernetes cluster 150 that is used to maintain network rules. These network rules allow for network communication with pods 144 from network sessions inside and/or outside of Kubernetes cluster 150.

Kubelet 158 on each host 111 is an agent that helps to ensure that one or more pods 144 run on each host 111 according to a defined state for the pods 144, such as defined in a configuration file. Each pod 144 may include one or more containers 152.

Control plane 160 includes components such as an API server 162, a controller 164, a cluster store (etcd) 166, and a scheduler 168. Control plane 160's components make global decisions about Kubernetes cluster 150 (e.g., scheduling), as well as detect and respond to cluster events.

API server 162 operates as a gateway to Kubernetes cluster 150. As such, a command line interface, web user interface, users, and/or services communicate with Kubernetes cluster 150 through API server 162. In certain aspects, ingress 180 runs on API server 162.

Controller 164 is a control plane 160 component that runs and manages controller processes in Kubernetes cluster 150. For example, control plane 160 may have (e.g., four) control loops called controller processes, that watch the state of Kubernetes cluster 150 and try to modify the current state of Kubernetes cluster 150 to match an intended state of Kubernetes cluster 150. In certain aspects, controller processes of controller 164 are configured to monitor for changes to the state of Kubernetes cluster 150.

Scheduler 168 is a control plane 160 component configured to allocate new pods to hosts 111. Additionally, scheduler 168 may be configured to distribute workloads, across containers, pods, and/or hosts 111 that are assigned to use resources of hardware platform 172. Resources may refer to processor resources, memory resources, networking resources, and/or the like. In some cases, scheduler 168 may schedule newly created containers to one or more of the hosts 111.

In other words, control plane 160 manages and controls every component of Kubernetes cluster 150. Control plane 160 handles most, if not all, operations within Kubernetes cluster 150, and its components define and control Kubernetes cluster 150's configuration and state data. Control plane 160 configures and runs the deployment, management, and maintenance of the containerized applications. As such, ensuring high availability of the control plane may be critical to container deployment and management. High availability is a characteristic of a component or system that is capable of operating continuously without failing.

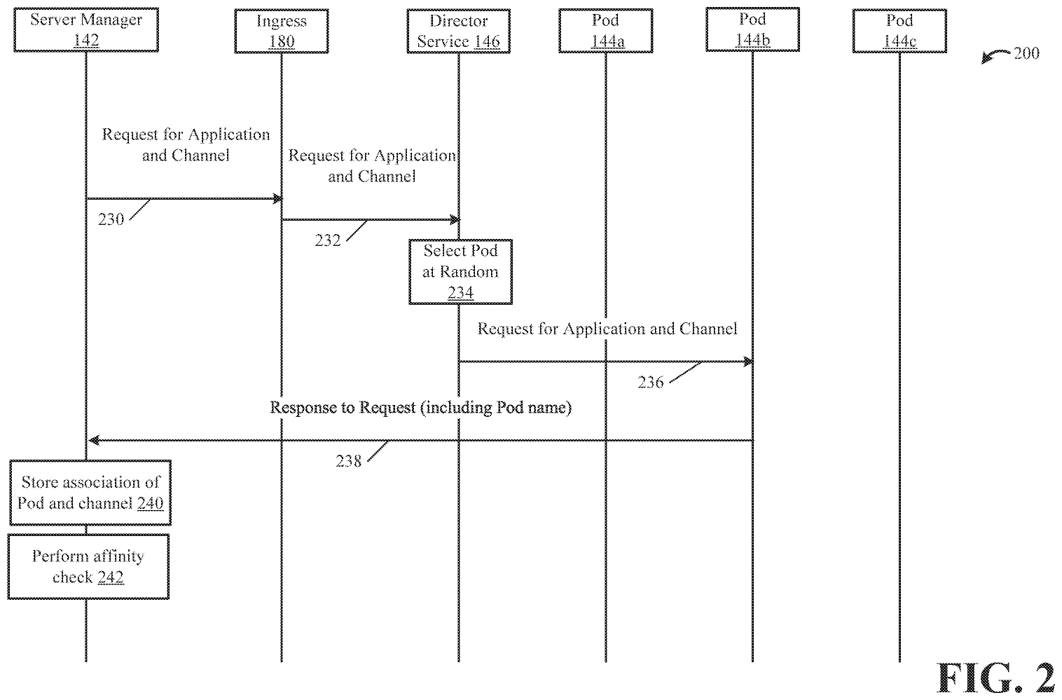

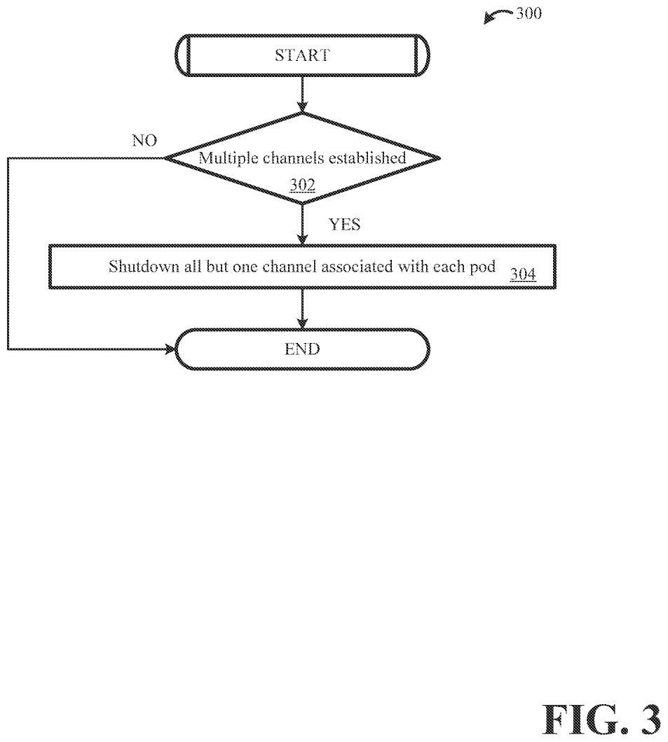

FIG. 2 depicts a sequence diagram of a process 200 for performing an affinity check, according to an example embodiment of the present application. As illustrated in line 230, server manager 142 may send a request to the ingress 180 for an application exposed by director service 146, the application running on pods of cloud environment 104. The request may correspond to a request to form a channel with one of the pods running the application. In line 232, ingress 180 may send the request to director service 146. In box 234, the director service 146 may select a pod 144 at random from a set of pods associated with the director service 146. As discussed above, according to the Kubernetes protocol, the director service 146 may receive a client request for the application and select a pod running an instance of the application at random. In line 236, director service 146 may send the request to the randomly selected pod (in this example, pod 144b). In line 238, the randomly selected pod may send a response to the request to server manager 142. The response may include the pod name. In box 240, the server manager 142 may store an association of the pod and the channel for performing the affinity check. In box 242, server manager 142 may perform the affinity check, such as according to the process 300 described with respect to FIG. 3.

FIG. 3 depicts a flowchart of a process 300 for removing redundant channels to the same pod of a service, according to an example embodiment of the present application. In certain aspects, process 300 corresponds to block 242 of FIG. 2, performing an affinity check. In certain aspects, process 300 occurs periodically at a client device, and not necessarily directly after a new association between a pod and a channel as shown in FIG. 2.

At block 302, the server manager 142 checks whether multiple channels created for director service 146 are established with the same pod. If there are not multiple channels established with the same pod, process 300 ends. If there are multiple channels established with the same pod, at block 304, server manager 142 shuts down all but one channel associated with each pod for which multiple channels are established. For example, assuming that server manager 142 has established two channels with pod 144a, three channels with pod 144b, and no channels with pod 144c, server manager 142 may shut down one of the channels with pod 144a and two of the channels with pod 144b. Process 300 may then end.

In certain aspects, after process 300 ends, server manager 142 establishes a new channel for each channel shut down at block 304, such as by performing steps 230-240 of process 200 of FIG. 2 for each new channel to establish. In the example where three channels were shut down, server manager 142 performs steps 230-240 three times.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by at least one processor of a computing system, cause the computing system to perform a method, as described herein.

Although one or more embodiments of the present application have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for removing redundant channels between a client and pods of a service, the method comprising:
sending, from the client to the service, a first request for an application exposed by the service, the first request corresponding to a request for a first channel;
receiving, at the client from a first pod associated with the service, a response indicating acceptance of the first request, establishment of the first channel between the first pod and the client, and an identifier of the first pod;
storing, in a data structure associating channels with pods of the service, an association between the first channel and the name of the first pod;
determining whether any pod is associated with multiple channels in the data structure; and
in response to determining that the first pod is associated with the first channel and one or more other channels, shutting down the one or more other channels.

2. The method of claim 1, further comprising, in response to shutting down the one or more other channels, sending, from the client to the service, one or more additional requests for one or more additional channels to replace the one or more other channels.

3. The method of claim 1, wherein determining whether any pod is associated with multiple channels in the data structure is performed periodically by the client.

4. The method of claim 1, wherein sending, from the client to the service, the first request is performed via an ingress.

5. The method of claim 1, wherein the first pod includes a plurality of containers running workloads of the application.

6. The method of claim 1, wherein the first pod runs in a virtual machine.

7. The method of claim 1, wherein the service is a Kubernetes service.

8. A system for removing redundant channels between a client and pods of a service comprising:
at least one processor; and
at least one memory, the at least one processor and the at least one memory configured to cause the system to:
send, from the client to the service, a first request for an application exposed by the service, the first request corresponding to a request for a first channel;
receive, at the client from a first pod associated with the service, a response indicating acceptance of the first request, establishment of the first channel between the first pod and the client, and an identifier of the first pod;
store, in a data structure associating channels with pods of the service, an association between the first channel and the name of the first pod;
determine whether any pod is associated with multiple channels in the data structure; and
in response to determining that the first pod is associated with the first channel and one or more other channels, shut down the one or more other channels.

9. The system of claim 8, wherein the at least one processor and the at least one memory are further configured to cause the system to:
in response to shutting down the one or more other channels, send, from the client to the service, one or more additional requests for one or more additional channels to replace the one or more other channels.

10. The system of claim 8, wherein determining whether any pod is associated with multiple channels in the data structure is performed periodically by the client.

11. The system of claim 8, wherein sending, from the client to the service, the first request is performed via an ingress.

12. The system of claim 8, wherein the first pod includes a plurality of containers running workloads of the application.

13. The system of claim 8, wherein the first pod runs in a virtual machine.

14. The system of claim 8, wherein the service is a Kubernetes service.

15. A non-transitory computer-readable medium for removing redundant channels between a client and pods of a service comprising instructions that, when executed by at least one processor of a computing system, cause the computing system to perform operations comprising:
sending, from the client to the service, a first request for an application exposed by the service, the first request corresponding to a request for a first channel;
receiving, at the client from a first pod associated with the service, a response indicating acceptance of the first request, establishment of the first channel between the first pod and the client, and an identifier of the first pod;
storing, in a data structure associating channels with pods of the service, an association between the first channel and the name of the first pod;
determining whether any pod is associated with multiple channels in the data structure; and
in response to determining that the first pod is associated with the first channel and one or more other channels, shutting down the one or more other channels.

16. The non-transitory computer-readable medium of claim 15, the operations further comprising:
in response to shutting down the one or more other channels, send, from the client to the service, one or more additional requests for one or more additional channels to replace the one or more other channels.

17. The non-transitory computer-readable medium of claim 15, wherein determining whether any pod is associated with multiple channels in the data structure is performed periodically by the client.

18. The non-transitory computer-readable medium of claim 15, wherein sending, from the client to the service, the first request is performed via an ingress.

19. The non-transitory computer-readable medium of claim 15, wherein the first pod includes a plurality of containers running workloads of the application.

20. The non-transitory computer-readable medium of claim 15, wherein:
the first pod runs in a virtual machine, and
the service is a Kubernetes service.
